(19) United States
(12) Patent Application Publication
(10) Pub. No.: US 2022/0252040 A1
(43) Pub. Date: Aug. 11, 2022

(54) WIND TURBINE AND WIND TURBINE ROTOR BLADE

(71) Applicant: Wobben Properties GmbH, Aurich (DE)

(72) Inventor: Alexander HOFFMANN, Emden (DE)

(21) Appl. No.: 17/610,992

(22) PCT Filed: May 15, 2020
(86) PCT No.: PCT/EP2020/063638

§ 371 Date: Nov. 12, 2021

(30) Foreign Application Priority Data
May 16, 2019 (DE) 10 2019 112 945.1

(51) Int. Cl. F03D 1/06; F03D 7/02; F03D 80/70

(52) U.S. Cl. CPC F03D 1/0675; F03D 1/0658; F03D 1/0633; F05B 2260/79; F03D 80/70; F05B 2240/302; F03D 7/0224

(57) ABSTRACT

A wind turbine comprising at least one rotor blade hub and at least one wind turbine rotor blade, wherein the wind turbine rotor blade is at least of a three-part configuration and has a rotor blade root region, a central region and a rotor blade tip region. In addition an end of the rotor blade root region is non-rotatably fixed to the rotor blade hub and a first pitch bearing is provided between a second end of the rotor blade root region and a first end of the central region. In addition there is provided a second pitch bearing between a second end of the central region and a first end of the rotor blade tip region.

### BACKGROUND

### Technical Field

The present invention concerns a wind turbine and a wind turbine rotor blade.

### Description of the Related Art

Wind turbines typically have three rotor blades, the pitch angles of which are adjustable. Typically provided at the transition between a rotor hub and the rotor blade is a pitch bearing, by means of which the pitch angle or the adjustment angle of the rotor blades can be set. In the case of earlier wind turbines it is known that only the blade tip is adjustable while the remainder of the rotor blade is fixedly connected to a rotor hub.

Wind turbines typically have a hub and rotatable rotor blades on the hub. The rotor blades can be rotated into or out of the wind by adjustment of the pitch angle of the rotor blades. The power and the rotary speed of the rotor of the wind turbine can be influenced by adjustment of the rotor blades. The longer the rotor blades and thus the heavier the rotor blades are the correspondingly greater are the adjusting forces required to change the pitch angle of the rotor blades. With an increasing mass in respect of the rotor blades on the one hand the maximum regulating speed falls while on the other hand the motors for pitch adjustment have to become larger.

EP 2 802 769 B1 discloses a wind turbine having a hub and at least one blade fixed to the hub. The blade has a first and a second blade portion, the first blade portion being stationarily fixed to the hub. The second blade portion is connected to the first blade portion by way of a rotary bearing. This means that the rotary bearing is no longer disposed directly between the hub and the rotor blade root of the rotor blade.

With an increasing length of the rotor blades the loading on a pitch bearing between the rotor hub and the rotor blade also increases.

On the German patent application from which priority is claimed the German Patent and Trade Mark Office searched the following documents: DE 10 2008 037 605 A1, DE 10 2014 203 508 A1, DE 296 02 674 U1, U.S. Pat. No. 7,939,961 B1, US 2014/0 322 013 A1 and EP 2 802 769 B1.

### BRIEF SUMMARY

Provided is a wind turbine which permits a reduced loading on a pitch bearing.

Provided is a wind turbine comprising a rotor hub and at least one rotor blade stationarily on the rotor hub. The rotor blade is of a three-part configuration and has a rotor blade root region, a central region and a rotor blade tip region. The rotor blade root region is fixed stationarily to the hub. A first pitch bearing is provided between the rotor blade root region and the central portion and a second pitch bearing is provided between the central region and the rotor blade tip region. Thus there is provided a rotor blade having two pitch bearings which are arranged in mutually spaced relationship along the longitudinal axis of the rotor blade. The first pitch bearing is now no longer provided directly at the rotor hub but is spaced in relation to the rotor hub.

According to an aspect, the length of the rotor blade root region is at least 10%, in particular at least 20%, of the overall length of the rotor blade. The overall length of the rotor blade is composed of the rotor blade root region, the central portion and the rotor blade tip region. The length of the rotor blade therefore extends from the transition of the rotor hub at the rotor blade root region to the rotor blade tip.

According to an aspect, the rotor blade root region is stationarily fixed directly to the rotor hub and in particular screwed. That provides that the rotor blade root region or an inner blade is secured fixedly and non-rotatably to the hub.

According to an aspect, the rotor blade root region can represent the widest portion of the rotor blade. A rotor blade chord in the region of the rotor blade root region can thus be larger than the chords of the rotor blades in the central or rotor blade tip region. Optionally the at least three regions can be of a multi-part configuration. In that case the division can be parallel or perpendicular to the longitudinal axis.

According to an aspect, the rotor diameter is at least 70 m. According to an aspect, the first pitch bearing is in the form of a circular pitch bearing and a connecting element for a direct screw connection at both sides.

The second pitch bearing represents for example a doubly supported tube plug-in connection.

The length of the rotor blade can vary by a variation in the length of the rotor blade root portion, the central region and the rotor blade tip portion so that it is possible to achieve 27 different rotor blade lengths by a variation in the length of the three rotor blade portions when each rotor blade portion is of three different lengths. In that way it is possible to achieve a wide variation in the length of the rotor blades without the production effort and involvement being considerably increased. In that respect for example only nine different rotor blade portions have to be produced.

According to a further aspect, the pitch angle of the central region and of the rotor blade tip portion together can be adjusted by rotation of the first pitch bearing. Only the rotor blade tip region is varied by rotation of the second pitch bearing while the rotor blade root region and the central portion do not permit any change in the pitch angle. A completely new pitch or partial pitch control of the rotor blades is made possible by the two mutually spaced pitch bearings.

Provided is a wind turbine rotor blade comprising at least three regions, namely a rotor blade root region, a central region and a rotor blade tip region. The rotor blade is thus at least of a three-part configuration. The rotor blade root region can be fixedly connected to the rotor blade hub at one end. For that purpose there can be provided a plurality of screws. A first pitch bearing is provided between the rotor blade root region and the central region, that is to say at the second end of the rotor blade root region. A second pitch bearing is provided between the central region and the rotor blade tip region. The wind turbine rotor blade thus has at least a first and a second pitch bearing.

According to an aspect, the length of the rotor blade root region is at least 10% and in particular at least 20% of the overall length of the rotor blade.

The wind turbine rotor blade or a wind turbine as described herein makes it possible to achieve a simplification in production and rotor blade transport as the rotor blade is of at least a three-part configuration. It is also possible to achieve standardization of the components of the rotor blades as a few different forms for the three parts of the rotor blade can result in 27 different rotor diameters. The rotor blade is of a three-part configuration and each component can be of three different lengths. In addition it is possible to achieve a reduction in the weight of the supporting structure as thicker profiles can be used, which can be adjusted in more specifically targeted fashion in regard to critical incident flow conditions.

The controllability of the rotor blades can be improved with the wind turbine and the wind turbine rotor blade with at least two pitch bearings. In addition a load reduction and an increase in output can be achieved with a lower level of sound emission. The lower level of sound emission can be achieved by preventing flow separation phenomena.

By virtue of the provision of two pitch bearings which are provided spaced from the rotor blade it is possible to reduce the loads acting on the transition between the rotor hub and the rotor blade. In addition the costs for the pitch bearings can be reduced as they can be designed for lower loads.

With the wind turbine rotor blade, it is possible that the rotor blade is designed in optimum fashion not only precisely for one operating state (wind speed, air density, rotary speed, adjustment angle, local twist angle, profile geometry and so forth) but with the rotor blade it is possible to optimize various operating states in respect of which the overall efficiency can be improved over the operating range.

With the rotor blade, it is possible to counteract in specifically targeted fashion local attack angle changes in the aerodynamic profiles, for example local flow stall phenomena. In that way it is possible for rotor blade regions to be provided with a substantially lesser attack angle reserve (reserve to a stall situation) and the rotor blade can be designed at those locations with thicker and larger profiles. That is further advantageous in regard to flexural stiffness as that increases quadratically with a linearly increasing profile thickness. That can lead to a considerable reduction in weight and thus cost. Upon a reduction in the profile depths that can lead to a reduction in the loading on the wind turbine.

The at least three-part rotor blade considerably simplifies transport of the respective parts of the rotor blade in comparison with a one-piece rotor blade.

Further configurations of the invention are subject-matter of the appendant claims.

### BRIEF DESCRIPTION OF THE SEVERAL VIEWS OF THE DRAWINGS

Advantages and embodiments by way of example of the invention are described in greater detail hereinafter with reference to the drawings.

FIG. 1 shows a diagrammatic view of a wind turbine according to a first embodiment of the invention, and

FIG. 2 shows a diagrammatic view of a wind turbine rotor blade according to a second embodiment of the invention.

### DETAILED DESCRIPTION

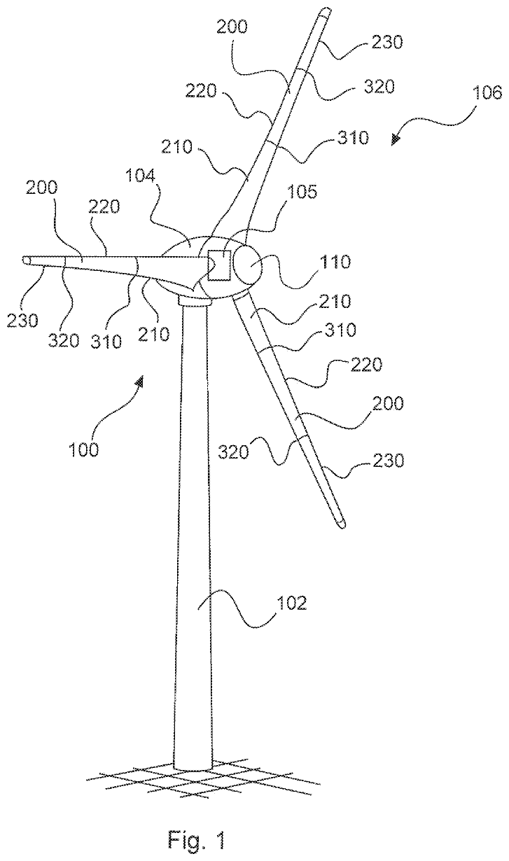

FIG. 1 shows a diagrammatic view of a wind turbine according to a first embodiment. The wind turbine has a tower 102 having a nacelle 104 and an aerodynamic rotor 106. The aerodynamic rotor 106 has a spinner 110, a hub 105 and three rotor blades 200. The rotor blades 200 are stationarily and non-rotatably secured to the hub 105 in the region of the spinner 110. In other words the rotor blade root of the rotor blades 200 is secured stationarily and non-rotatably to the hub 105 of the wind turbine 100. Provided within the spinner 110 or the nacelle 104 is an electric generator connected directly or indirectly to the aerodynamic rotor 106 to generate electrical energy upon movement of the aerodynamic rotor 106.

The rotor blades 200 are of an at least three-part configuration and have at least a rotor blade root region 210, a central region 220 and a rotor blade tip region 230. A first end of the rotor blade root region 210 is fixed to the hub 105 (directly or indirectly, for example by way of a hub adaptor). A second end of the rotor blade root region 210 is coupled to a first end of the central region 220 by way of a first pitch bearing 310. A second end of the central region 220 is coupled to the rotor blade tip region 230 by way of a second pitch bearing 320. In that way the pitch angle of the central region 220 and the pitch angle of the rotor blade tip region 230 can be altered (in relation to the orientation of the rotor blade root region 210).

Preferably the first pitch bearing 310 can be operated independently of the second pitch bearing 320 and vice-versa. The direction of rotation of the first pitch bearing can correspond to that of the second pitch bearing. As an alternative thereto the two directions of rotation can differ from each other. A corresponding consideration applies to the speed of rotation.

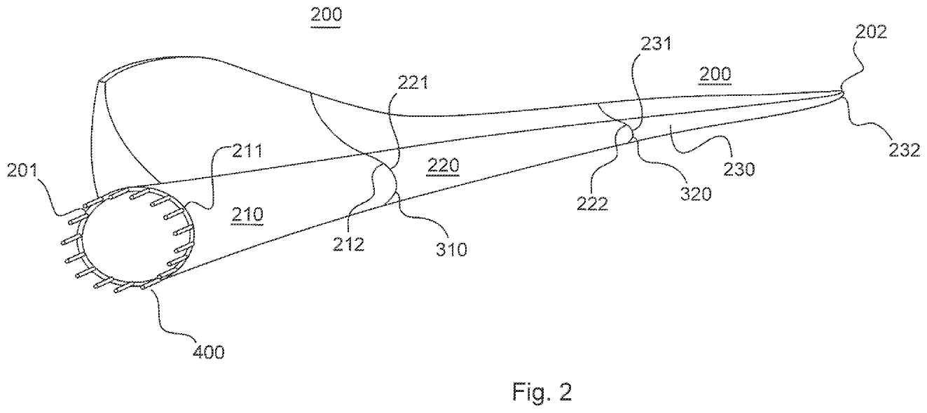

FIG. 2 shows a diagrammatic view of a wind turbine rotor blade according to a second embodiment of the invention. The rotor blade 200 has at least one rotor blade root region 210, a central region 220 and a rotor blade tip region 230 which together provide the rotor blade 200. The rotor blade 200 is thus at least of a three-part configuration. As an alternative thereto the rotor blade 200 can also be of more than a three-part configuration. In that case the above-described three regions can each be for example of a multi-part configuration.

The rotor blade root region 210 has a first and a second end 211, 212. The central region 220 has a first and a second end 221, 222. The rotor blade tip region 230 has a first and a second end 231, 232. The rotor blade 100 further has a rotor blade root 201 and a rotor blade tip 202. The first end 211 of the rotor blade root region 210 substantially corresponds to the rotor blade root 201. The rotor blade 200 can be directly or indirectly fixed to a hub 105 of the wind turbine 100 by means of the first end 211 of the rotor blade root region 210. In particular the fixing is stationary or non-rotatable, that is to say the rotor blade root region 210 is non-rotatable with respect to the hub.

In contrast to the rotor blades according to the state of the art therefore no pitch bearing and no pitch motor are provided at the transition between the rotor blade hub and the rotor blade root.

Rather, according to the disclosure, a first pitch bearing 310 is provided between the second end 212 of the rotor blade root region 210 and the first end 221 of the central region 220. At least one pitch motor is also provided in the region of the pitch bearing 310 so that the central region 220 is rotatable relative to the second end 212 of the rotor blade root region 210. A second pitch bearing 320 is provided in the region of the transition between the second end 222 of the central region 220 and the first end 231 of the rotor blade tip region 230 so that the rotor blade tip region 230 can be rotated relative to the central region 220.

The pitch angle of the central region 220 is thus adjustable. Furthermore the pitch angle of the rotor blade tip region 230 is also adjustable.

The direction of rotation of the first pitch bearing can correspond to that of the second pitch bearing. As an alternative thereto the two directions of rotation can differ from each other. A corresponding consideration applies to the speed of rotation.

Optionally the first and second pitch bearings 310, 320 can be operated independently of each other. Thus for example the pitch angle of the central region 220 can be altered without an alteration in the pitch angle of the rotor blade tip region 230. In a corresponding fashion it is also possible to alter only the pitch angle of the rotor blade tip region 230 without altering the pitch angle of the central region 220.

According to an aspect, the width of the rotor blade root region 220 is greater than the width of the central portion 220 or the rotor blade tip region 230.

According to an aspect, the rotor blade diameter is at least 70 m.

According to an aspect, it is possible to achieve lower loads and thus lower costs in regard to the pitch bearings by displacement of the pitch plane to the connecting location between the respective parts of the rotor blade. The hub can thus be smaller by virtue of the fact that the rotor blade root is non-rotatably fixed to the hub.

According to an aspect, the pitch bearing can be provided in the form of a connecting portion between the respective parts of the rotor blade. That can optionally be effected by means of a direct screwing connection or a cross-bolt connection. That can lead to a simpler flange construction. In addition in that way no slot opening for a tool insert and the like has to be provided.

In the second pitch plane (that is to say between the central region 220 and the rotor blade tip region 230) the pitch and connecting mechanism can be implemented by way of two singly supported tube plug-in connections with an adjusting drive. That is advantageous because that is technically easier to handle than the rotor blades according to the state of the art.

There can be a height offset between the parts of the rotor blade by virtue of the connecting pitch bearing. That height offset can optionally be aerodynamically uncoupled by a boundary layer protection fence.

According to an aspect, there can be provided a blade opening to be able to retighten the outer ring of screws from the interior of the blade. That blade opening can also be used as a lift opening.

1. A wind turbine comprising:
a single rotor blade hub; and
three wind turbine rotor blades,
wherein each of the three wind turbine rotor blades is of at least a three-part configuration and has at least a rotor blade root region, a central region and a rotor blade tip region,
wherein each rotor blade root region has a respective end that is fixed non-rotatably to the rotor blade hub,
a first pitch bearing between a second end of the rotor blade root region and a first end of the central region of one wind turbine rotor blade of the three wind turbine rotor blades, and
a second pitch bearing between a second end of the central region and a first end of the rotor blade tip region of one wind turbine rotor blade of the three wind turbine rotor blades.

2. The wind turbine according to claim 1 wherein a length of each of the rotor blade root regions is at least 10% of an overall length of the respective rotor blade of the three wind turbine rotor blades.

3. The wind turbine according to claim 1 wherein each rotor blade includes a rotor blade chord in a region of the respective rotor blade root region that is greater than rotor blade chords in the central region and in the rotor blade tip region.

4. The wind turbine according to claim 1 wherein the rotor blade root regions, the central regions and the rotor blade tip regions of each rotor blade of the three wind turbine rotor blades are configured to be transported separately.

5. The wind turbine according to claim 1 wherein the first and second pitch bearings are operable independently of each other.

6. The wind turbine according to claim 1 wherein a direction of rotation and a speed of rotation of the first and/or second pitch bearings are different from each other.

7. A wind turbine rotor blade comprising:
at least a rotor blade root region, a central region, and a rotor blade tip region,
wherein an end of the rotor blade root region is configured to be non-rotatably fixed to a rotor blade hub of a wind turbine,
a first pitch bearing between a second end of the rotor blade root region and a first end of the central region, and
a second pitch bearing between a second end of the central region and a first end of the rotor blade tip region.
